(19) United States
(12) Patent Application Publication
(10) Pub. No.: US 2009/0271728 A1
(43) Pub. Date: Oct. 29, 2009

(54) VISUAL REPRESENTATION MANIPULATION

(75) Inventors: Jason Andrew Weber, Wauwatosa, WI (US); Gregory J. Shuler, Muskego, WI (US); Joseph T. Bronikowski, New Berlin, WI (US); Todd A. Vance, West Bend, WI (US); Jeffrey Foley, Muskego, WI (US); Russell W. Brandes, Brunswick, OH (US); Adam B. Maki, Claremont, NH (US)

Correspondence Address: TUROCY & WATSON, LLP;ATTENTION: HEATHER HOLMES, 127 Public Square, 57th Floor, Key Tower, Cleveland, OH, 44114, US

(73) Assignee: Rockwell Automation Technologies, Inc., Mayfield Heights, OH (US)

(21) Appl. No.: 12/111,708

(22) Filed: Apr. 29, 2008

(51) Int. Cl. G06F 3/048; G06F 17/00

(52) U.S. Cl. 715/771

(57) ABSTRACT

An industrial control configuration can be disclosed to a user as a specific representation, such as a physical layout of different units of the configuration. A user can seamlessly move between different representations, such as switching from the physical layout to a logical layout. The representations can provide real time information and disclose animations to a user that represent different states of a unit or generally of a layout.

### TECHNICAL FIELD

The subject specification relates generally to modeling of an industrial control system and in particular to disclosing different views of an industrial control system upon a single construct.

### BACKGROUND

Industrial control environments can typically involve complex mechanical, electronic, electromechanical, and/or robotic machinery that perform various automated mechanical and/or electrical functions. Such machinery can include industrial motors, pumps, conveyors, escalators, drills, refrigeration systems, and so on, that can provide a particular physical output. Typically, an industrial environment utilizes one or more control devices to determine when to activate or deactivate such machinery, as well as an appropriate level of activation, (e.g., an amount of current to supply a variable input motor). Additionally, the control devices are associated with logical program code that can determine an appropriate time, degree, manner, etc., to operate such machinery based on various determinable circumstances (e.g., output of another device, reading of an optical sensor, electronic measurement such as current level in a device, movement or number of rotations of a device, and so on).

Different controls can be used to provide protective features in an industrial environment. If a user attempts to make a change upon the industrial environment, then various checks can take place to discover if a user is authorized to make the change, such as requesting the user to enter a username and password. In addition, the user can be provided various tools that can assist in making changes to the industrial environment, including providing a template to be used to make different modifications.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

To view different portions of an industrial control system in a conventional setting, multiple panes can be used to show different views and/or information. If a user wants to change a view, then she minimizes an old pane and opens a window with desired information. In some instances, a user becomes confused and disorientated and it becomes difficult for the user to appreciate the control system as a whole.

With the disclosed innovation, a visual representation (e.g., three-dimensional) of an industrial control system can be presented to a user, where the representation can function as a seamless model of the control system. The user can manipulate the visual representation while operating within a single construct. For instance, the user can zoom from a representation of a plant-wide control system into an sub-section or a single control device; change perspectives by zooming into a control code executing inside a control device; change perspectives again to look at the manufacturing function or area being controlled by the control code (e.g. a mixing tank or a packaging machine); change perspective again to view the production scheduling and utilization of that machine or function; and zoom out to view plant-wide or enterprise-wide production planning across all equipment and plants—all within one construct. A manipulation command can be received to alter the representation and then the command is seamlessly implemented upon the representation.

While three-dimensional modeling and seamless model integration may have some development in other areas, using these techniques and others practiced with the disclosed innovation goes against conventional thought in industrial control system research circles. It appears illogical to allow an industrial control system visual representation to be viewed and/or manipulated in the disclosed manner due to the complexity of many control systems, such as intricate relationships between controllers. However, unexpected advantages can take place in practicing the disclosed innovation, such as allowing a user to understand the industrial control system quickly and easily.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative system for operating a visual representation of an industrial control configuration in accordance with an aspect of the subject specification.

FIG. 2 illustrates a representative manipulation of a visual representation of an industrial control configuration in accordance with an aspect of the subject specification.

FIG. 3 illustrates a representative system for operating a visual representation of an industrial control configuration with a detailed collection component in accordance with an aspect of the subject specification.

FIG. 4 illustrates a representative system for operating a visual representation of an industrial control configuration with a detailed function component in accordance with an aspect of the subject specification.

FIG. 5 illustrates a representative system for operating a visual representation of an industrial control configuration with a detailed construction component in accordance with an aspect of the subject specification.

FIG. 6 illustrates a representative methodology for manipulation operations that relate to a visual representation in accordance with an aspect of the subject specification.

FIG. 7 illustrates a representative methodology related to rule configuration related to manipulation of a visual representation in accordance with an aspect of the subject specification.

FIG. 8 illustrates a representative methodology for detailed construction and utilization of an industrial control system visual representation in accordance with an aspect of the subject specification.

FIG. 9 illustrates an example of a schematic block diagram of a computing environment in accordance with an aspect subject specification.

FIG. 10 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

As used herein, the terms to “infer” or “inference” refer generally to the process of reasoning about or deducing states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. It is to be appreciated that determinations and/or inferences disclosed throughout the subject specification can be implemented through practice of artificial intelligence techniques.

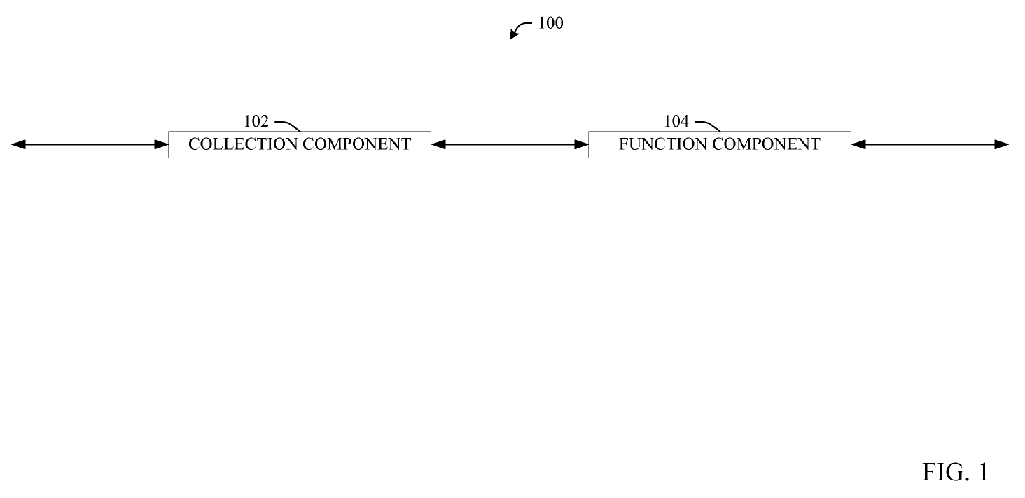

Now referring to FIG. 1, an example system 100 is disclosed for manipulating a visual representation of an industrial control configuration. The visual representation can implement as a three-dimensional model, where controllers and other units are disclosed a functional blocks. Dynamic blocks can be used that highlight particular functionality—if a controller is approaching a critical failure, then a representative block can flash red.

The visual representation can be presented to a user and the user can provide a response, such as how a view should be changed. Additionally, the visual representation can include a controller hardware device, a field device, mechanical equipment, a vendor software system, user-developed control code, a software artifact, or a combination thereof. A collection component 102 can obtain a command to manipulate a visual representation of an industrial control system, commonly with regard to scope of the visual representation. Command obtainment can occur passively (e.g., the collection component 102 waits for a command to be produced), actively (e.g., the user is provided a prompt in order to solicit a command), and the like.

A function component 104 can implement the gathered command to facilitate manipulation of the visual representation, where implementation of the command occurs in a single construct (e.g., a single window of a computer application). The manipulation can include broadening visual scope of the industrial control system, narrowing visual scope of the industrial control system, changing a domain display of the visual representation, addition of a portion of the visual representation, removal of a portion of the visual representation, or a combination thereof. As part of the implementation, the function component 104 can analyze the command and determine a proper manner in which to perform implementation. For example, the user can take a mouse pointer, click on a mouse button to indicate an action, and rotate the pointer in a manner indicative to how the user wants the representation to move. The function component 104 can analyze the user action, determine what the user intends with the action, and perform a deed related to the determination.

A visual representation of an industrial control system can have multiple different scopes that a user can desire to navigate. A physical representation can disclose hardware devices and/or network conductivity, communication between hardware and software, logical hierarchy, control codes mapping to physical devices, operational status of the system, manufacturing execution system (MES) representation, actual representation, etc. Use of the system 100 can allow a user to navigate seamlessly between different scopes, such as from the MES representation to communication between hardware and software.

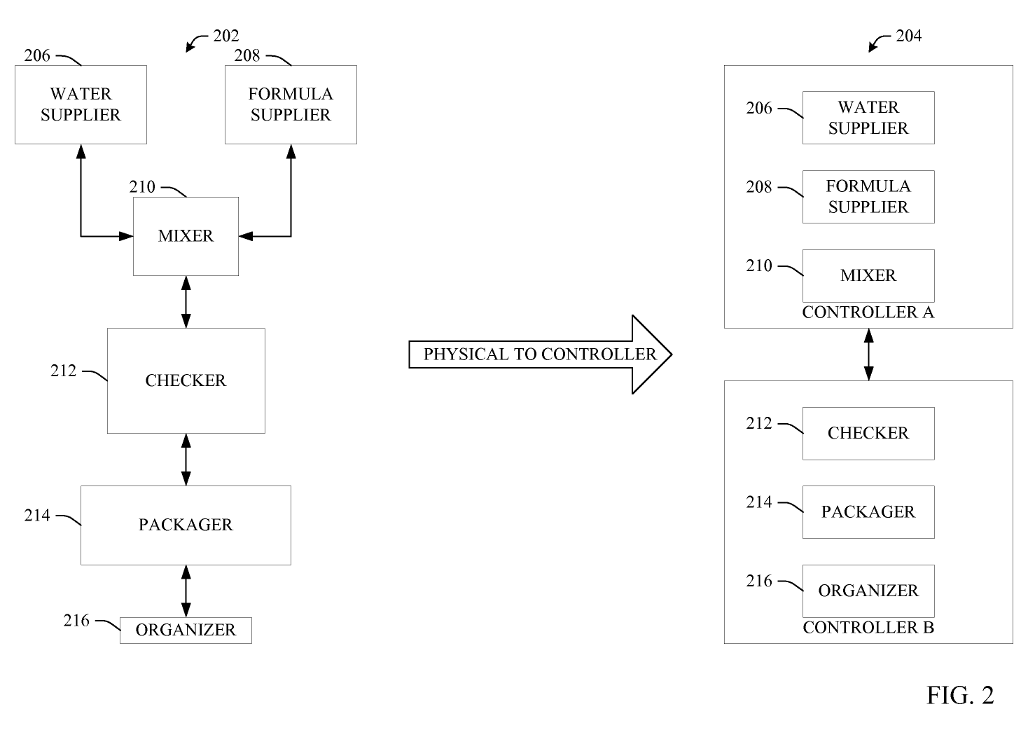

Now referring to FIG. 2, example configurations 202 and 204 of a control system are disclosed. The configurations 202 and 204 disclose different representations of a soda making system, which can be automatically generated or produced by a user with certain access rights. A water supplier 206 and a formula supplier 208 can produce water and formula respectively to a mixer 210. The mixer 210 can combine the water and mixture to create soda, commonly through a specified process (e.g., adding the formula to the water at a set rate). A checker 212 can determine if the combination occurred correctly and perform certain functionality, such as disposing of mixture if there is an error. A packager 214 and organizer 216 can bottle the soda and place the bottles into consumable units (e.g., groupings of twelve surrounded by cardboard) respectively.

Different configurations can be utilized for different information to be appreciated with relation to the soda making system. A physical configuration 202 can disclose how different units interact with one another and how they physically align. The suppliers 206 and 208 feed product into the mixer 210. Then other units linearly process product, which is shown through the configuration 202. However, a user can desire to view controllers quickly that operate the different units. Therefore, a change can take place where the physical configuration 202 converts to a controller configuration 204. To facilitate the change, according to one embodiment a user can enter a request through a keyboard, mouse, microphone, and the like. Two different controllers can operate different units of the system. Controller A can organize the making of the soda while controller B prepares the soda for public sale. The user can switch between these configurations as well as a plurality of other configurations. The configurations can be static or dynamic (e.g., a flashing icon to identify a controller that is functioning in error). Additionally, there can be a playback feature to configuration disclosure, such as if a dynamic module representation shows a fluid level and the level changes over time, a user can request to see fluid movement for a previous period.

The collection component 102 of FIG. 1 can obtain a command to change scope of a configuration, such as from the physical configuration 202 to the controller configuration 204. The command can originate from a user, automatically, and the like. The command can be implemented by the function component 104 of FIG. 2, such that the configuration 202 is replaced with the configuration 204 upon a display screen.

Moreover, a user can desire that a different format would be more applicable in certain situations. For instance, a visual representation can be a logical view of different devices, where functional blocks represent different units. However, mere functional blocks do not show how a system physically integrates together, different parts that make up a unit, etc. The collection component 102 of FIG. 1 can infer that the visual representation is inadequate and generate a command (e.g., the command is obtained through generation) to show a better view. The function component 104 of FIG. 1 can determine a visual representation that is better suited for needs of the user and automatically implement the command. According to another embodiment, a user can be asked to confirm an automatic command implementation.

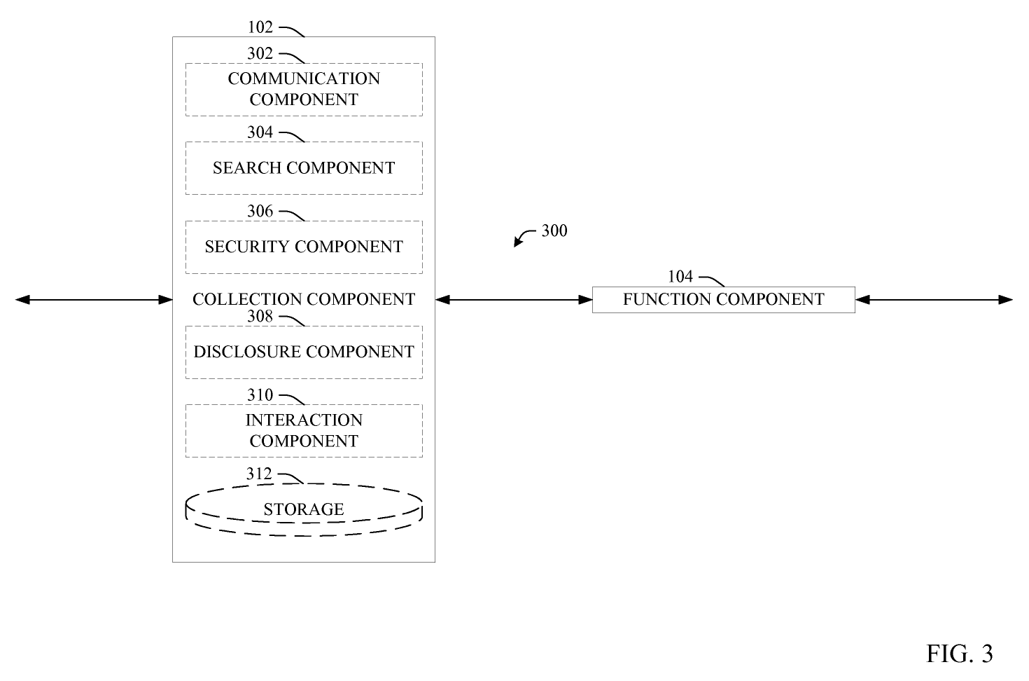

Now referring to FIG. 3, an example system 300 is disclosed for manipulating a visual representation of an industrial control configuration with an expanded representative collection component 102. The collection component 102 can obtain a command to manipulate a visual representation of an industrial control system. A communication component 302 can engage with other devices to transfer information. Operation can take place wirelessly, in a hard-wired manner, employment of security technology (e.g., encryption), etc. Moreover, the communication component 302 can utilize various protective features, such as performing a virus scan on obtained data and blocking information that is positive for a virus.

A search component 304 can discover information related to the visual representation, where the information is associated with the command. For instance, the search component 304 can retain information that is related to the visual representation before and after modification. Moreover, the search component 304 can be utilized to discover units that will be represented in a modified version.

A security component 306 can authorize a user to provide the command that is obtained, where the user cannot submit the command (e.g., place the command in a functional state) without authorization. For example, a user can be provided a high-level overview of the control system; however, specific operations of some units are protected trade secrets. The security component 306 can determine if a user is authorized to view protected information and limit/block user access if not authorized. The security component 306 can also regulate implementation of the gathered command as a function of user rights, user privilege, user role, or user preference.

A disclosure component 308 can present the visual representation, oftentimes to a user. A non-exhaustive list of disclosure components includes a display screen (e.g., renders in three-dimensional modeling, rendering in two dimensional modeling, etc.), speaker system, virtual reality environment, Braille production system, printer, etc. In addition, the disclosure component 308 can present information in multiple formats, such as showing a video with audio capabilities.

An interaction component 310 can facilitate command obtainment thought engagement of a user. Example interaction components can include a keyboard, mouse, microphone, touch screen, tablet personal computer, etc. The interaction component 310 and disclosure component 308 can integrate as one unit, such as a display screen with touch capabilities.

Different pieces of information, such as obtained information, component operating instructions (e.g., interaction component 310), source location, copies of discovered information, a list of approved entities for utilization by the security component 306, etc. can be held on storage 312. Storage 312 can arrange in a number of different configurations, including as random access memory, battery-backed memory, hard disk, magnetic tape, etc. Various features can be implemented upon storage 312, such as compression and automatic back up (e.g., use of a Redundant Array of Independent Drives configuration). A function component 104 can implement the gathered command upon the visual representation, where implementation of the command occurs in a single construct.

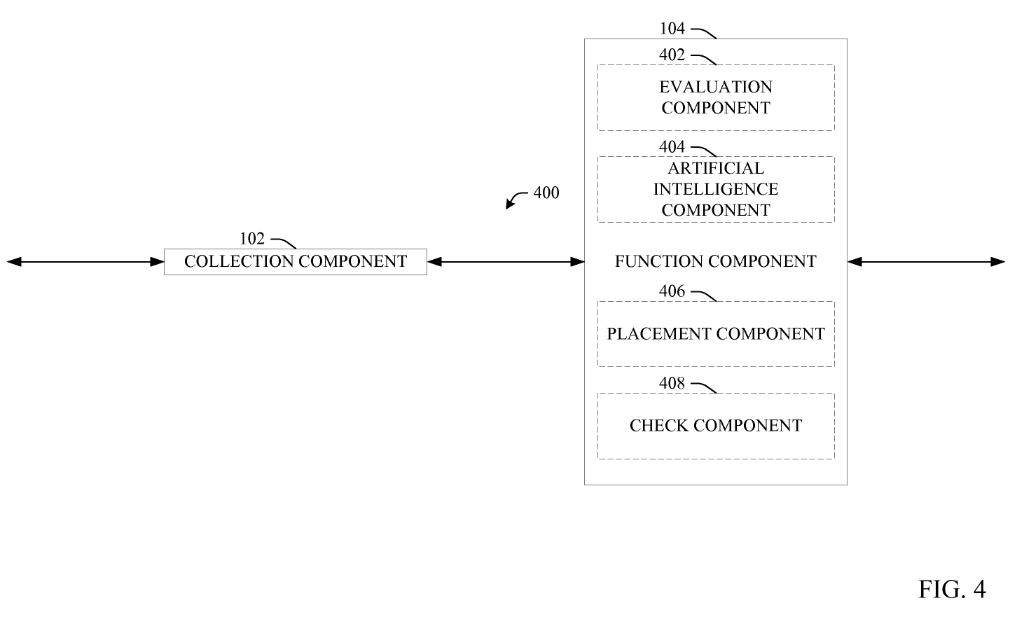

Now referring to FIG. 4, an example system 400 is disclosed for manipulating a visual representation of an industrial control configuration with an expanded representative function component 104. A collection component 102 can obtain a command to manipulate a visual representation of an industrial control system. The function component 104 can implement the gathered command upon the visual representation, where implementation of the command occurs in a single construct.

An evaluation component 402 can analyze a command to resolve what is intended with the command. For instance, a command from a mouse scroll button where a user rotated the button away from her can be interpreted by the evaluation component 402 as an instruction to zoom-in. In addition, feasibility checks can be made—a request to view actual video of a control system can be denied by the evaluation component 402 if footage is not available.

An artificial intelligence component 404 can make at least one inference or at least one determination in relation to command obtainment or command implementation. For example, the artificial intelligence component 404 can make an inference if a received action of a user is accidental or if the user intends the action to be a manipulation command. In an illustrative determination, the artificial intelligence component 402 can determine an access level of a user.

The artificial intelligence component 404 can employ one of numerous methodologies for learning from data and then drawing inferences and/or making determinations related to applying a service (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. Methods also include methods for the capture of logical relationships such as theorem provers or more heuristic rule-based expert systems. According to one embodiment, the artificial intelligence component 508 can operate as a means for identifying a problem of an application through implementation of a user-defined rule. For example, if an error is discovered in a particular controller, a scope can be automatically changed to enable the user to gather more information concerning the error. Using the soda making process described in FIG. 2, a configuration displayed can change from the physical configuration 202 to an actual configuration that discloses live video of a system. The user can visually see water is not moving from the water supplier 206 of FIG. 2 to the mixer 210 of FIG. 2 through a broken hose. Moreover, the disclosure component 308 of FIG. 3 can present a fault in the industrial control system and the artificial intelligence component 404 determines information for presentment with the presented fault as a function of estimated benefit to a user evaluating the fault. The artificial intelligence component 404 can be used to predict a representation to disclose to a user and the prediction can be automatically implemented; however, rules-based practices can be implemented. Also, the artificial intelligence component 404 can perform adaptive learning such that predictions can be improved over time.

A placement component 406 can populate at least a portion of the discovered information upon the visual representation with the implemented command. In one implementation, the search component 304 of FIG. 3 retains information of a pre-modification representation. Once modification is implemented, but before presented to a user, a determination is made as to what information should be disclosed with the modified representation. Retained information can be first populated as needed and then the search component 304 of FIG. 3 finds new information in accordance with instructions from the placement component 406, where newfound information can be populated with the representation. The populated and modified representation can be disclosed to the user.

A check component 408 can ensure that a modified version of the representation is appropriate. It is possible that the placement component 406 populated so much information upon the representation that there is a relatively high likelihood of user confusion (e.g., the likelihood is calculated by the check component 408). In this example case, the check component 408 can modify the modified representation in order to lower a likelihood of confusion.

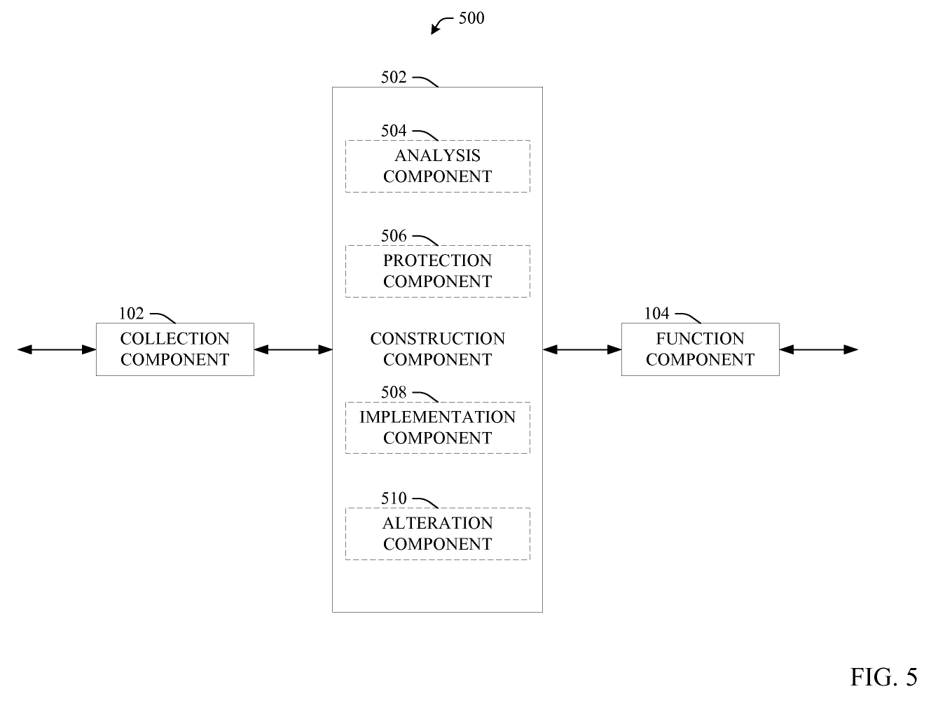

Now referring to FIG. 5, an example system 500 is disclosed for building a visual representation of an industrial control configuration with an expanded representative construction component 502. A command can be obtained by the collection component 102 to build a visual representation of an industrial control system. Based on this command, the collection component 102 can learn about the control system and gather related information, such as where controllers are located, status of controllers, and the like. The collection component 102 can function as a means for gathering metadata (e.g., error data, layout information, etc.) related to an industrial control configuration.

Based upon obtained information of the control system, a construction component 502 can build the visual representation of the industrial control system. According to one embodiment, the collection component 102 learns about a device that is to be used in display of the representation and the construction component 502 can build the representation in view of device capabilities (e.g., color display). The construction component 502 can operate at least in part as a as a means for constructing a visual representation of the industrial control configuration based upon at least a portion of the gathered metadata, a means for animating at least a portion of the visual representation, where the animation represents a state of at least a portion of the industrial control system, means for selecting a default view for the visual representation, the default view is initially shown when presenting the visual representation, or a combination thereof.

An analysis component 504 can process obtained information and make determinations upon the obtained information. For instance, based upon an analysis result, a determination can be made as to a physical layout of the control system. The analysis component 504 can implement as a means for analyzing the gathered metadata, a result of the analysis is used in visual representation construction.

The protection component 506 can share capabilities with the security component 306 of FIG. 3 and vice versa. The protection component 506 can determine if a user or entity has authorization to view a representation of the industrial control system and block un-authorized users/entities accordingly. The protection component 506 can perform as a means for determining an access level of an anticipated viewer of the visual representation, the visual representation is constructed as a function of the determination (e.g., thought utilization of the artificial intelligence component 404 of FIG. 4).

Oftentimes, rules are used to dictate how a representation is constructed and/or how a representation is modified. The implementation component 508 can utilize the rules in building/modifying the visual representation. The implementation component 508 can operate as a means for implementing at least one rule, construction of the visual representation is based upon at least one rule.

There are times that rules become outdated, counterproductive, and the like. A user can access and alteration component 510 and make a variety of changes upon the rules. Alteration of rules can include creating a new rule, deleting a rule, modifying a rule, and so on, where alteration is performed by a user and/or performed automatically. The alteration component 510 can function as a means for altering at least one rule utilized in construction of the visual representation.

Once the visual representation is built, various amounts of functionality can be added by a function component 104. In addition, the function component 104 can enable display (e.g., through the disclosure component 308 of FIG. 3) of a new or modified representation. The function component 104 can implement as a means for enabling uninterrupted navigation of the visual representation.

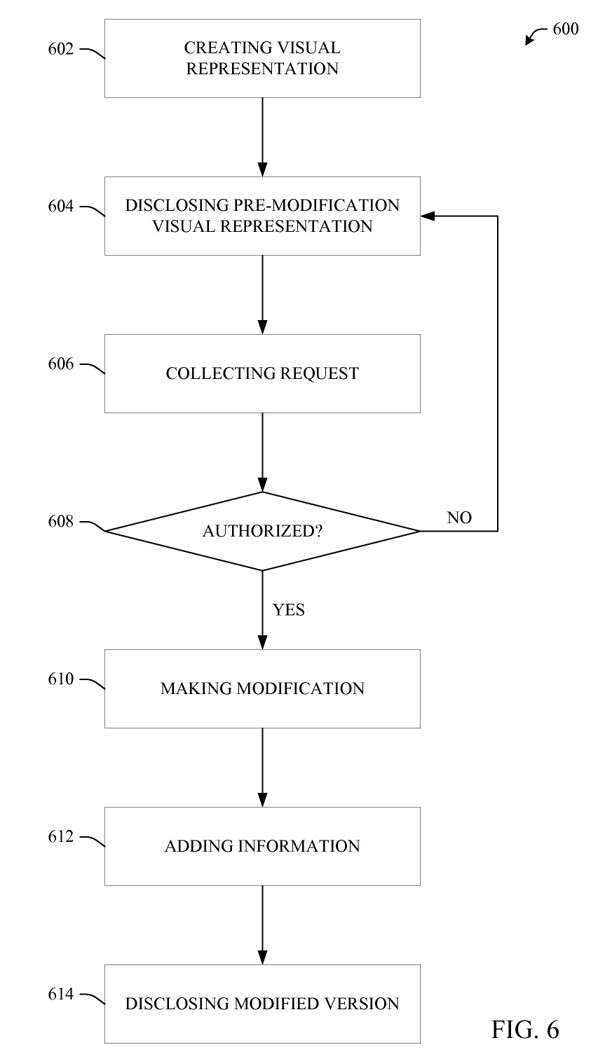

Now referring to FIG. 6, an example methodology 600 is disclosed for modifying a visual representation of an industrial control system, commonly in real time. At block 602, metadata of the industrial control system can be gathered and based upon the gathered metadata, the visual representation can be constructed. A search can occur of information sources and a determination can be made as to information relevant toward creating the visual representation. According to one embodiment, creation can take place organically—a visual representation is only created as far as what is shown to a user; as the user makes navigation requests, the representation is further constructed to comply with the request.

At event 604, the constructed visual representation can be presented to a user or an entity (e.g., an automated unit). The presentment can take place automatically, such as when construction completes as well as when a user requests the representation. In order for the user/entity to view the representation, she can be required to supply a password, proper credentials, or the like.

A request can be generated to modify the visual representation and collected at act 606. Oftentimes the modification is cosmetic, which does not change structure of the visual representation. For instance, this can include rotating the visual representation, magnifying the visual representation, changing format of the visual representation, or a combination thereof.

A check 608 can be made to determine if a requesting entity is authorized to view the visual representation in accordance with the request. This can be similar to checks make at event 604; however, there can be different requirements to view a representation and to change the representation. For instance, at a presentation, multiple parties can have access rights, but a speaker has right to modify the representation. If a request is not authorized (e.g., a requestor is not authorized, a request itself is not authorized, and the like), then the unmodified version can continue to be presented.

If the user is authorized, no authorization is needed, and so on, then the modification requested (e.g., in whole, in part, an altered version, etc.) can be made upon the representation at event 610. The request can be explicit (e.g., change from the physical configuration 202 of FIG. 2 to the controller configuration 204 of FIG. 2) where the request is placed. Moreover, the request can be general (e.g., show the logical map) and a determination can be made on how to accomplish the request. Event 610 can include making a modification upon an industrial control configuration visual representation.

The modified visual representation can be analyzed to determine information that should be added/subtracted/changed and the information can be added/subtracted/changed at action 612. For example, a rotation of a representation can take some controllers out of view and information concerning the out-of-view controllers can be removed. Different pieces of information can have security requirements that are checked and used in determining if information is to be added, changed, and so on.

The modified version of the representation with the added information can be disclosed to the user at act 614. This commonly replaces what is disclosed through event 604, however, other implementations are possible. Additionally, one visual representation can be presented to multiple parties, where a manipulation of one party does not influence presentation to another party. Act 614 can include disclosing the modified industrial control configuration visual representation as a continuation from the pre-modification industrial control configuration visual representation. While action 612 is shown as intervening event 610 and act 614, it is to be appreciated that event 610 and act 614 can operate together independent of other actions, acts, events, or the like.

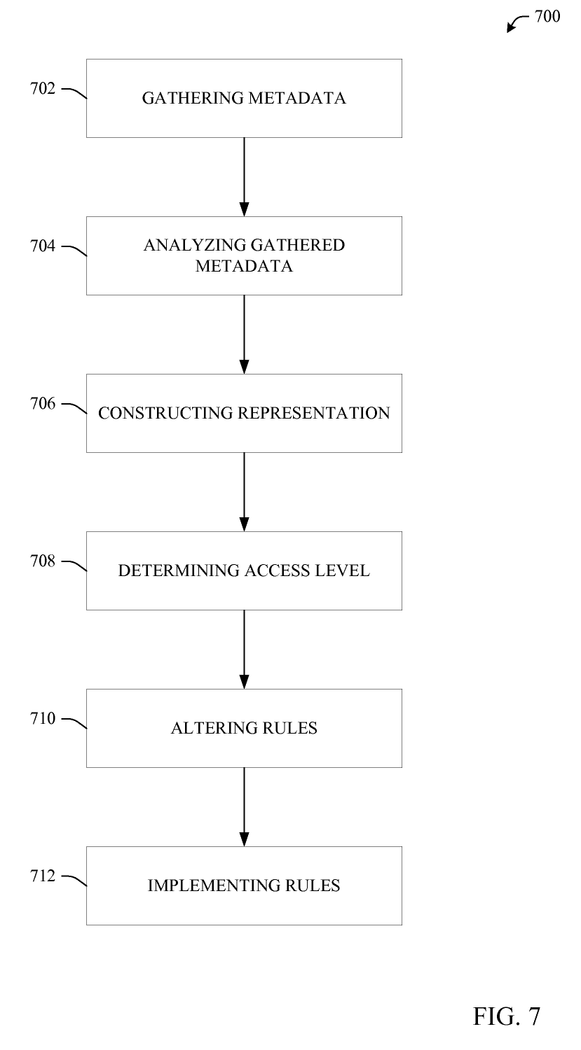

Now referring to FIG. 7, an example methodology 700 is disclosed for constructing a visual representation of an industrial control system and performing operations in relation to rules used to construct the representation. Metadata related to the industrial control system can be gathered at event 702. Example information includes controller details, relationships between different entities, and the like.

The gathered information can be analyzed in order to learn how the representation should be configured at act 704. Analysis of the metadata allows for a greater understanding of how a system configures and in turn how a visual model should configure. For instance, relative addresses can collected and analysis can determine how far physically different units are from one another based upon the addresses.

At block 706, the visual representation can be constructed based off a result of the analysis. Determinations can be made as to what items belong in the representation. In an illustrative example, a controller can be considered important, but a transformer can be viewed as inconsequential and excluded from the representation. Rules can be used to assist in determining what is considered important—the rules can be produced from a person as well as created automatically by user observation (e.g., users historically delete transformers from the representation).

A request from a user to alter rules used to construct the representation can be gathered and a determination can be made if a user is authorized to change the rules at event 708. Rule can apply locally, such as to a specific user or project team, as well as globally. Access criteria can be different based on rule applicability—it can require a higher access level to modify a global rule over a local rule.

The user can make modifications to the rules and the modified rules are saved in storage for later usage at action 710. The rules can be specific to a particular user (e.g., a programmer can benefit from different rules then a maintenance worker). Prior to action 710, a user modifying rules can run diagnostic tests upon the rules to ensure that the rules have desired functionality. The user can replace old rules with altered rules in storage that achieve a desired goal of the user.

At block 712, the rules can be implemented such that other visual representation can be built upon the rules and/or an operational representation can be changed in accordance with the modified rules. As other representations are created, the new rules can be used as opposed to the older rules. In addition, active representations can be changed according to the new rules—however, the methodology 700 can configure without updating existing representations.

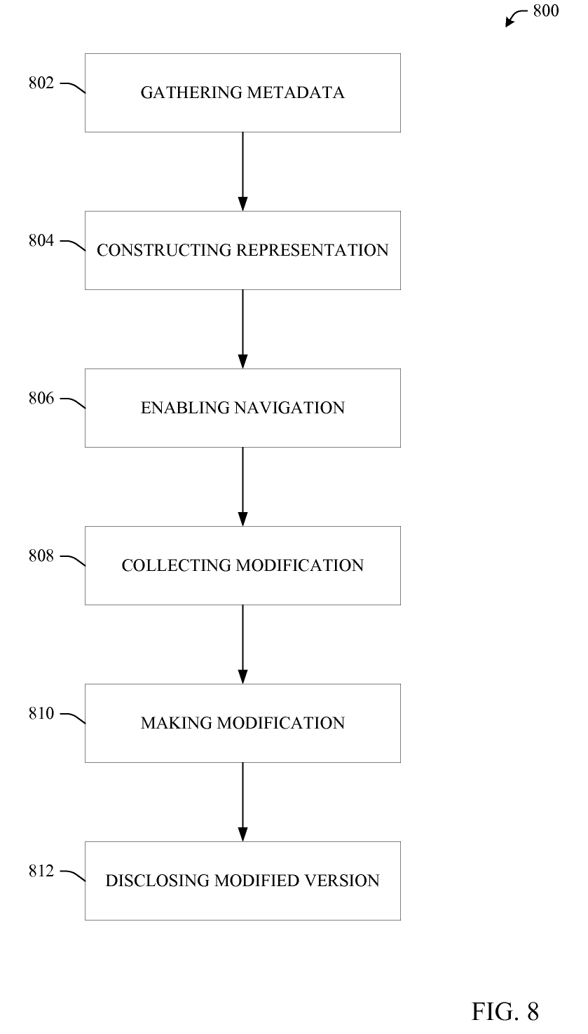

Now referring to FIG. 8, an example methodology 800 is disclosed for creating and modifying a visual representation. Metadata related to the industrial control system can be gathered at action 802. A piece of collected metadata can be compared with other metadata to verify consistency. If inconsistent data is discovered, rules can be used to resolve the inconsistency (e.g., comparing device history of having accurate information). Action 802 can retain similar functionality to operation of event 702 of FIG. 7 and vice versa.

At block 804, the visual representation of the industrial control system can be constructed. This can include at least some portions of the methodology 700 of FIG. 7. The constructed representation can be presented to a user and navigation of the representation can be enabled at act 806. Navigation can allow a user to rotate the visual representation, magnify the visual representation, change format of the visual representation, or a combination thereof.

The user can request to navigate through the representation, thus facilitating a modification (e.g., a movement of the representation) at event 808. At action 810, the modification requested by the user can be made upon the visual representation. The modified version of the representation can be disclosed to the user at act 812.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

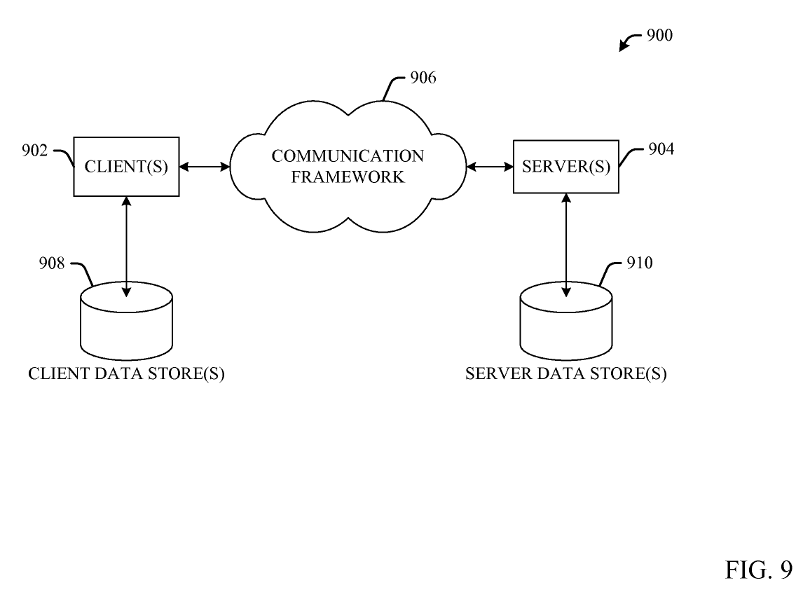

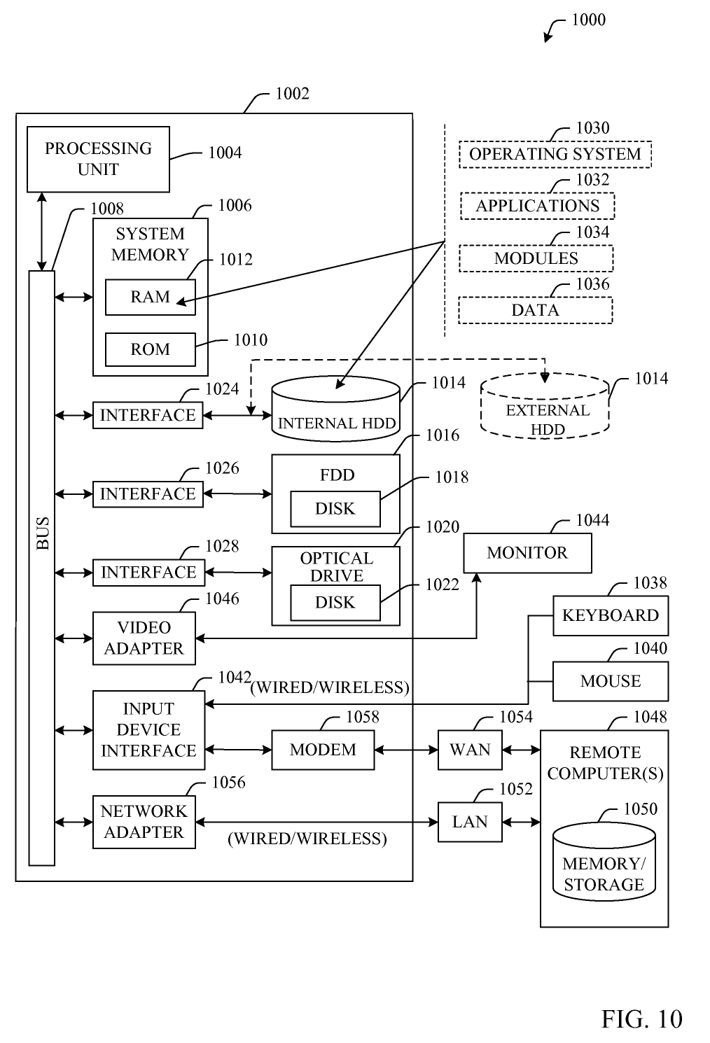

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embody computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors or proprietary specific configured processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various proprietary or commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the input device interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The aforementioned systems have been described with respect to interaction among several components. It should be appreciated that such systems and components can include those components or sub-components specified therein, some of the specified components or sub-components, and/or additional components. Sub-components can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system capable of implementation upon an industrial control configuration, comprising:
a collection component that obtains a command to manipulate the visual representation of an industrial control system with regard to scope; and
a function component that implements the gathered command to facilitate manipulation of the visual representation, where implementation of the command occurs in a single construct.

2. The system of claim 1, further comprising a search component that discovers information related to the visual representation, where the information is associated with the command.

3. The system of claim 2, further comprising a placement component that populates at least a portion of the discovered information upon the visual representation with the implemented command.

4. The system of claim 1, further comprising an artificial intelligence component that makes at least one inference or at least one determination in relation to command obtainment or command implementation.

5. The system of claim 4, further comprising a disclosure component that presents a fault in the industrial control system, the artificial intelligence component determines information for presentment with the presented fault as a function of estimated benefit to a user evaluating the fault.

6. The system of claim 1, further comprising a security component that regulates implementation of the gathered command as a function of user rights, user privilege, user role, or user preference.

7. The system of claim 1, the visual representation includes a controller hardware device, a field device, mechanical equipment, a vendor software system, user-developed control code, a software artifact, or a combination thereof.

8. The system of claim 1, the manipulation includes broadening visual scope of the industrial control system, narrowing visual scope of the industrial control system, changing a domain display of the visual representation, addition of a portion of the visual representation, removal of a portion of the visual representation, or a combination thereof.

9. The system of claim 1, further comprising a construction component that builds the visual representation of the industrial control system.

10. A method, comprising:
making a modification upon an industrial control configuration visual representation; and
disclosing the modified industrial control configuration visual representation as a continuation from the pre-modification industrial control configuration visual representation.

11. The method of claim 10, further comprising constructing the industrial control configuration visual representation upon which the modification occurs.

12. The method of claim 10, further comprising collecting a request to modify the industrial control configuration visual representation.

13. The method of claim 12, further comprising verifying that the request to modify is authorized.

14. The method of claim 10, making the modification includes broadening visual scope of the industrial control system, narrowing visual scope of the industrial control system, changing a domain display of the visual representation, addition of a portion of the visual representation, removal of a portion of the visual representation, or a combination thereof.

15. A system capable of implementation upon an industrial control configuration, comprising:
means for gathering metadata related to an industrial control configuration;
means for constructing a visual representation of the industrial control configuration based upon at least a portion of the gathered metadata; and
means for enabling uninterrupted navigation of the visual representation.

16. The system of claim 15, further comprising means for analyzing the gathered metadata, a result of the analysis is used in visual representation construction.

17. The system of claim 15, further comprising means for implementing at least one rule, construction of the visual representation is based upon at least one rule.

18. The system of claim 17, further comprising means for altering at least one rule utilized in construction of the visual representation.

19. The system of claim 15, further comprising means for animating at least a portion of the visual representation, where the animation represents a state of at least a portion of the industrial control system.

20. The system of claim 15, further comprising means for selecting a default view for the visual representation, the default view is initially shown when presenting the visual representation.
